(19) United States
(12) Patent Application Publication
(10) Pub. No.: US 2013/0204562 A1
(43) Pub. Date: Aug. 8, 2013

(54) ELECTRONIC DEVICE AND METHOD FOR DETECTING VOLTAGE OF THE ELECTRONIC DEVICE

(71) Applicants: XIAO LIANG, Shenzhen City (CN); MING LI, Shenzhen City (CN)

(72) Inventors: XIAO LIANG, Shenzhen City (CN); MING LI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/531,144

(22) Filed: Jun. 22, 2012

(30) Foreign Application Priority Data
Feb. 7, 2012 (CN) 201210026428.4

(51) Int. Cl. G06F 19/00

(52) U.S. Cl. 702/64

(57) ABSTRACT

A method for detecting voltages of an electronic device determines a first number of events in a System Event Log (SEL) of the electronic device, acquires a first voltage of a specific component from the voltage sensor, and records a first time. After a first time interval has elapsed, a second number of the events is determined, and a second voltage of the specific component is acquired. An absolute value of a difference between the second and first voltage of the voltage sensor is calculated when the second number is equal to the first number. Abnormal information of the specific component is outputted when a time difference between the second and first time is less than a second time interval and a number of the absolute value is not less than a predetermined number.

### BACKGROUND

1. Technical Field

Embodiments of the present disclosure relate to voltage management technology, and particularly to an electronic device and method for detecting voltage of the electronic device.

2. Description of Related Art

An electronic device may have different kinds of sensors to detect various parameters of the electronic device. For example, the electronic device (e.g., a personal computer, a mobile phone) may have a plurality of voltage sensors to detect voltages of different components. Each of the voltage sensor may only have threshold values including an upper limit and a lower limit to determine whether the detected voltage is normal. That is, if the detected voltage changes within a range between the upper limit and the lower limit, no alarm signal is output. However, if the voltage of the electronic device fluctuates greatly within the range between the upper limit and the lower limit, the electronic device may suffer in performance or even physically from the fluctuating voltage. For example, if voltage of a motherboard in a computer fluctuates greatly, the motherboard may be damaged. Thus, it is necessary to detect fluctuating voltages of the electronic device and output an alarm promptly.

### BRIEF DESCRIPTION OF THE DRAWINGS

FIG. 1 is a block diagram of one embodiment of an electronic device including a voltage detection system.

FIG. 2 is a block diagram of one embodiment of the voltage detection system.

FIGS. 3A and 3B are flowcharts of one embodiment of a method for detecting voltages of the electronic device using the voltage detection system of FIG. 2.

FIG. 4 is a flowchart of one embodiment of a parsing procedure of step S20 in FIG. 3A.

### DETAILED DESCRIPTION

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

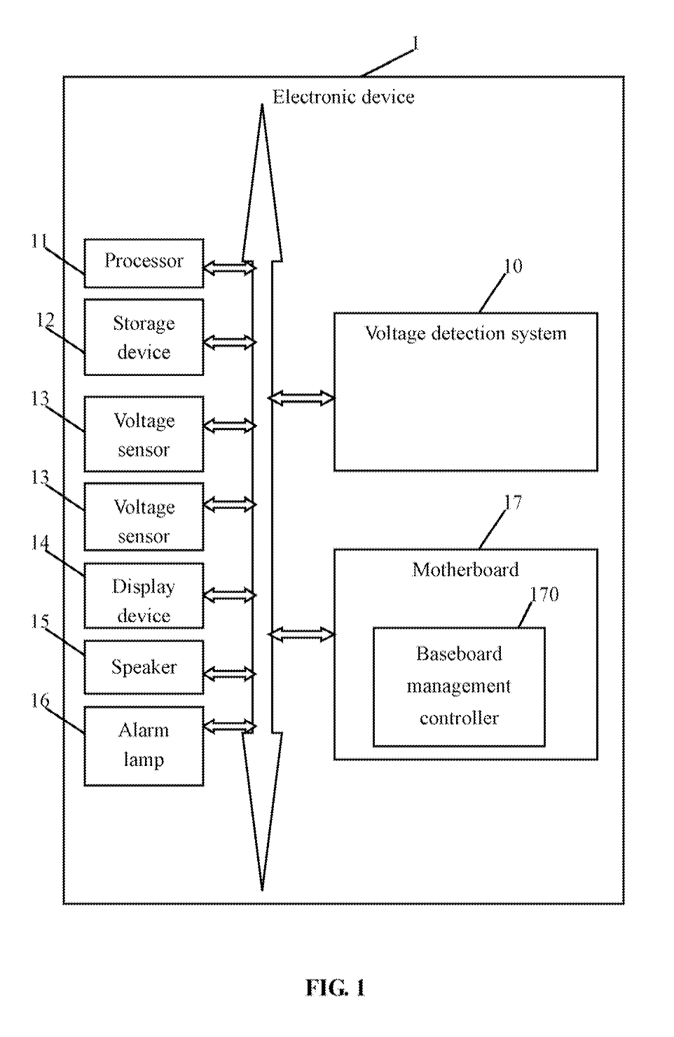

FIG. 1 is a block diagram of one embodiment of an electronic device 1 including a voltage detection system 10. The electronic device 1 may be a personal computer, a notebook computer, a tablet computer, a mobile phone, a personal digital assistant, or any other computing device. The electronic device 1 may include a plurality of voltage sensors 13 (only two are shown in FIG. 1). The voltage sensors 13 may be used to detect voltages of different components in the electronic device 1, such as, central processing unit (CPU), a south bridge chip, a north bridge chip, and a motherboard 17 of the electronic device 1, for example. In some embodiments, the motherboard 17 is regarded as one component in the electronic device 1.

In some embodiments, the voltage detection system 10 determines whether the voltage of the electronic device 1 is normal by comparing the voltage detected by the voltage sensors 13 and a predetermined parameter, and outputs alarm information when the voltage of the electronic device 1 is abnormal. The voltage detection system 10 may avoid damage to the electronic device 1 by fluctuating voltages. A detailed description of voltage detection system 10 will be given in the following paragraphs.

The electronic device 1 further includes at least one processor 11, a storage device 12, a display device 14, a speaker 15, an alarm lamp 16, and the motherboard 17. FIG. 1 illustrates only one example of the electronic device 1 that may include more or fewer components than illustrated, or have a different configuration of the various components.

The storage device 12 provides one or more memory functions. In one embodiment, voltage detection system 10 may include computerized instructions in the form of one or more programs that are executed by the at least one processor 11 and stored in the storage device 12. The storage device 12 stores one or more programs, such as programs of the operating system, other applications of the electronic device 1, and various kinds of data, such as video and image data. In some embodiments, the storage device 12 may include a memory of the electronic device 1 and/or an external storage card, such as a memory stick, a smart media card, a compact flash card, or any other type of memory card.

The display device 14 may be a liquid crystal display (LCD) or a touch-sensitive display, for example. The speaker 15 may be used to output audible data, such as music, or predetermined alarm information, for example. The alarm lamp 16 may be a light emitting diode (LED) lamp. In some embodiments, the alarm lamp 16 may be turned on to flash, for prompting a user of the electronic device 1 that the voltage is abnormal.

The motherboard 17 includes a baseboard management controller 170, which is a microcontroller embedded on the motherboard 17. The BMC 170 manages an interface between system management software and platform hardware of the electronic device 1. The electronic device 1 supports the Intelligent Platform Management Interface (IPMI) standard. In some embodiments, the IPMI and BMC 170 may cooperate to monitor different parameters of the electronic device 1, such as static parameters of the CPU, a memory, a hard disk, a network card, the operating system of the electronic device 1, and dynamic readings, of temperatures, of voltages, and of current consumed by the CPU, by the motherboard 17, and by other components in the electronic device 1, for example.

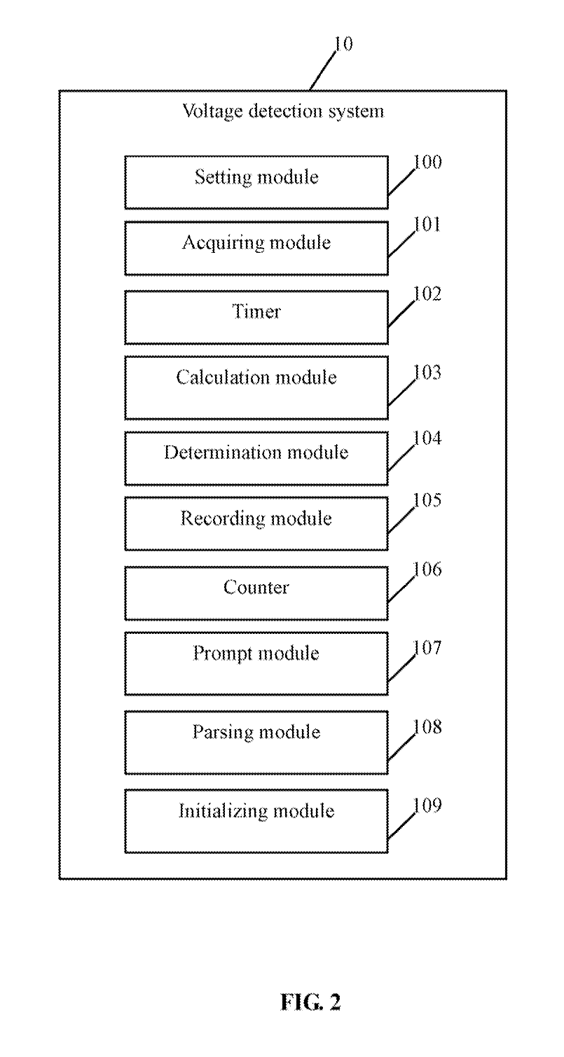

FIG. 2 is a block diagram of one embodiment of the voltage detection system 10. In one embodiment, the voltage detection system 10 may include one or more modules, for example, a setting module 100, an acquiring module 101, a timer 102, a calculation module 103, a determination module 104, a recording module 105, a counter 106, a prompt module 107, a parsing module 108, and an initialization module 109. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

The storage device 12 stores a difference between an upper limit and a lower limit of the voltage sensor 13. In some embodiments, the difference is used as a comparison value of the voltage sensor 13 to determine if voltage of one of the components in the electronic device 1 is normal, detailed descriptions are provided below. In some embodiments, the comparison value may be confirmed by the following steps.

First, the voltage detection system 10 reads information of different sensors in the electronic device 1, such as temperature sensors, the voltage sensors, and a gravity sensor, for example. The voltage detection system 10 may read the information using an “ipmitool” command based on the IPMI standard. The voltage detection system 10 recognizes the voltage sensors 13 from different sensors in the electronic device 1 according to the read information, the read information of the voltage sensors 13 include, but is not limited to a recognition keyword (e.g., “voltage”), an identifier, an upper limit, and a lower limit of each of the voltage sensors. For example, the voltage detection system 10 may search for the voltage sensors 13 using a “grep” command of the IPMI standard, and filter search data to determine/acquire information of the voltage sensors 13 using a “cat” command based on the IPMI standard. For example, a command of “cat/proc/devices|grep ipmidev” may be used to acquire identifier numbers of the voltage sensors 13.

The voltage detection system 10 stores the read information of the voltage sensors 13 into a file, and stores the file into the storage device 12. The voltage detection system 10 further calculates a difference between the upper limit and the lower limit of each of the voltage sensors 13, and writes the difference as the comparison value of each of the voltage sensors 13 into the file. The voltage detection system 10 may invoke the file using a “more” command in the IPMI standard, and acquire a target comparison value of a specific voltage sensor 13 according to the identifier using the “cat” command in the IPMI standard.

For simplification, one voltage sensor 13 is used as an example in the following embodiments to describe functions of all modules in the voltage detection system 10. The voltage sensor 13 may be installed to carry out voltage detection in relation to a specific component of the electronic device 1, such as the CPU, the motherboard 17, or any other component in the electronic device 1. In other embodiments, the following descriptions are applied to a plurality of voltage sensors 13 in the electronic device 1.

The setting module 100 presets a plurality of parameters, detailed descriptions on the parameters are provided below.

The acquiring module 101 determines a first number “A1” of events in a System Event Log (SEL) of the electronic device 1, acquires a first voltage “V1” of the specific component from the voltage sensor 13, and records a first time “T1” when acquiring the first voltage. For example, the number (e.g., quantity) of events in the SEL may be 10, thus, the first number “A1” is 10. In some embodiments, the acquiring module 101 accesses the SEL and the voltage sensor 13 through the BMC 170. The first time “T1” may be a timestamp, such as “8:00 AM”.

The timer 102 times a first time interval from the first time “T1”. The first time interval is predetermined by the setting module 100, such as 1 second, for example.

The acquiring module 101 further determines a second number “A2” of the events in the SEL after the first time interval has elapsed, and acquires a second voltage “V2” of the specific component from the voltage sensor 13. In some embodiments, once the first time interval has elapsed, the acquiring module 101 is trigged to execute the above mentioned actions and the timer 102 is reset to zero and begins to time the first time interval again.

The determination module 104 determines whether the second number “A2” is equal to the first number “A1”. In some embodiments, the SEL records abnormal events of the electronic device 1. When the second number “A2” is equal to the first number “A1”, that is “A2=A1”, it is represented that no abnormal events has occurred within the first time interval.

If the second number is equal to the first number, the calculation module 103 calculates a difference between the second voltage “V2” and the first voltage “V1” of the specific component, and determines an absolute value “C” of the difference. That is, “C=|V1−V2|”.

The determination module 104 acquires the comparison value “B” of the voltage sensor 13 from the storage device 12, and compares the comparison value with the absolute value “C” of the difference. The determination module 104 further determines whether the absolute value “C” of the difference is more than or equal to a predetermined percentage (e.g., 60%, or two-thirds) of the comparison value “B”. The predetermined percentage is set by the setting module 100.

If the absolute value “C” of the difference is more than or equal to a predetermined percentage of the comparison value, the recording module 105 records current time as a second time “T2” and records the absolute value “C” of the difference and the first voltage “V1” and the second voltage “V2” of the voltage sensor 13 in the storage device 12. The second time “T2” may be a timestamp, such as “8:05 AM”, for example.

In some embodiments, one absolute value “C” recorded in the storage device 12 is an indication that one abnormal event has occurred.

The counter 106 counts a number of the absolute value “C” recorded in the storage device 12, determines the number of abnormal events according to the number of the absolute value “C” in the storage device 12. That is, the number of the abnormal events is the same as the number of the absolute value “C” in the storage device 12.

The determination module 104 determines whether a time difference “T” between the second time “T2” and the first time “T1” is less than a second time interval (e.g., 1 minute) predetermined by the setting module 100. If the time difference “T” is less than the second time interval, the determination module 104 further determines whether the number of the absolute value “C” is equal to or more than a predetermined number (e.g., 20) set by the setting module 100.

If the time difference “T” is less than the second time interval and the number of the absolute value “C” is equal to or more than the predetermined number, the prompt module 107 outputs abnormal information of the voltage of the specific component in the electronic device 1. In some embodiments, the abnormal information may include, but is not limited to, a component name of the specific component that the voltage sensor 13 has been detected, the first voltage, the second voltage, and the difference between the second voltage and the first voltage of the specific component. The prompt module 107 may output the abnormal information by means including, but are not limited to, an audible alarm using the speaker 15, lighting the alarm lamp 16, displaying the abnormal information on the display device 14, and outputting the abnormal information using the display device 14, the speaker 15, and/or the alarm lamp 16.

If the time difference “T” is less than the second time interval and the number of the absolute value “C” is less than the predetermined number, the voltage detection system 10 continues and repeats the functions of the acquiring module 101, the timer 102, the calculation module 103, the determination module 104, the recording module 105 and the timer 106.

If the time difference “T” is equal to or more than the second time interval, the initializing module 109 initializes the counter 106 to clear or delete the number of the absolute value(s) in the storage device 12, and the acquiring module 101, the timer 102, the calculation module 103, the determination module 104, the recording module 105, and the counter 106 start again.

If the second number is different from the first number, the parsing module 108 is invoked to execute a parsing procedure. The parsing procedure includes the following steps. The parsing module 108 determines target events in the SEL created during the first time interval, and determines a recorded voltage value and a recorded time in each of the target events. As mentioned above, the SEL records abnormal events occurred in the electronic device. The abnormal events recorded in the SEL records component information of components that are determined to be abnormal. The component information includes, but is not limited to a component name, an identifier, and abnormal parameters (e.g., voltage) of each component. For example, the record of an abnormal event in relation to the CPU for example represents that the voltage of the CPU of the electronic device 1 is abnormal, the identifier of the voltage sensor that detects the CPU is “123” and the voltage is 5V.

The acquiring module 101 acquires a detected voltage value of the specific component detected by the voltage sensor 13 at the recorded time. The determination module 104 determines whether the detected voltage value is different from the recorded voltage value. In some embodiments, the comparison of the detected voltage value and the recorded voltage value is for determining whether the BMC 170 generates abnormal events correctly.

If the detected voltage value is different from the recorded voltage value, that is, the BMC 170 does not generate the abnormal events correctly, the recording module 105 determines the BMC 170 of the electronic device 1 is abnormal, and records corresponding abnormal information of the BMC 170. The prompt module 107 outputs abnormal information of the BMC 170.

In other embodiments, the electronic device 1 includes the plurality of voltage sensors 13. The parsing module 108 further determines an identifier of a particular voltage sensor 13 recorded in each of the target events, and determines a target voltage sensor 13 according to the identifier. The acquiring module 101 acquires the detected voltage value detected by the target voltage sensor 13 at the recorded time according to the identifier of the voltage sensor 13.

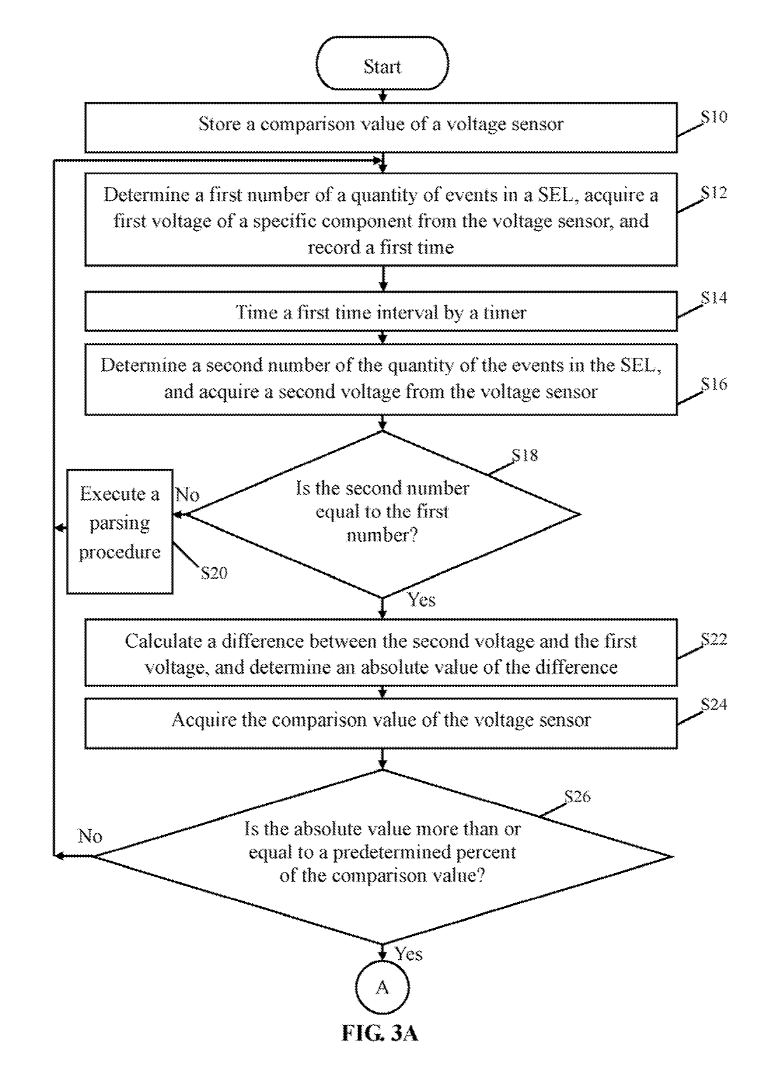

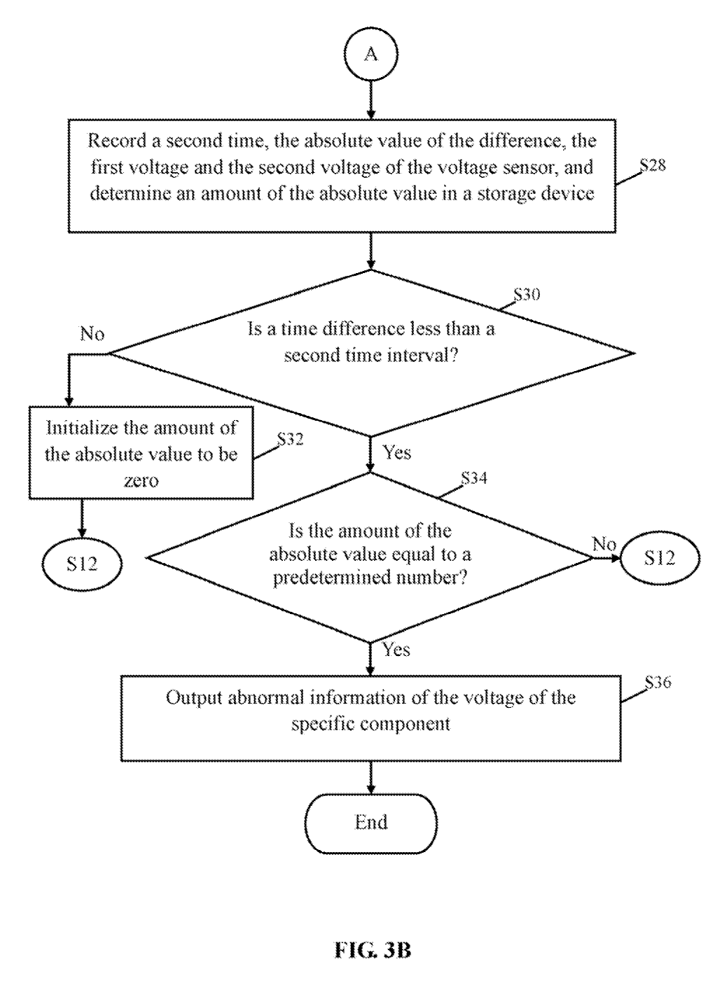

FIGS. 3A and 3B are flowcharts of one embodiment of a method for detecting voltages of the electronic device 1 using the voltage detection system 10 of FIG. 2. Depending on the embodiment, additional steps may be added, others removed, and the ordering of the steps may be changed.

In step S10, the storage device 12 stores a difference between an upper limit and a lower limit of the voltage sensor 13. The difference is confirmed to be a comparison value.

In step S12, the acquiring module 101 determines a first number “A1” of events in a SEL of the electronic device 1, acquires a first voltage “V1” of a specific component from the voltage sensor 13, and records a first time “T1” when acquiring the first voltage.

In step S14, the timer 102 times a first time interval from the first time “T1”.

In step S16, the acquiring module 101 further determines a second number “A2” of the events in the SEL after the first time interval has elapsed, and acquires a second voltage “V2” of the specific component from the voltage sensor 13.

In step S18, the determination module 104 determines whether the second number “A2” is equal to the first number “A1”.

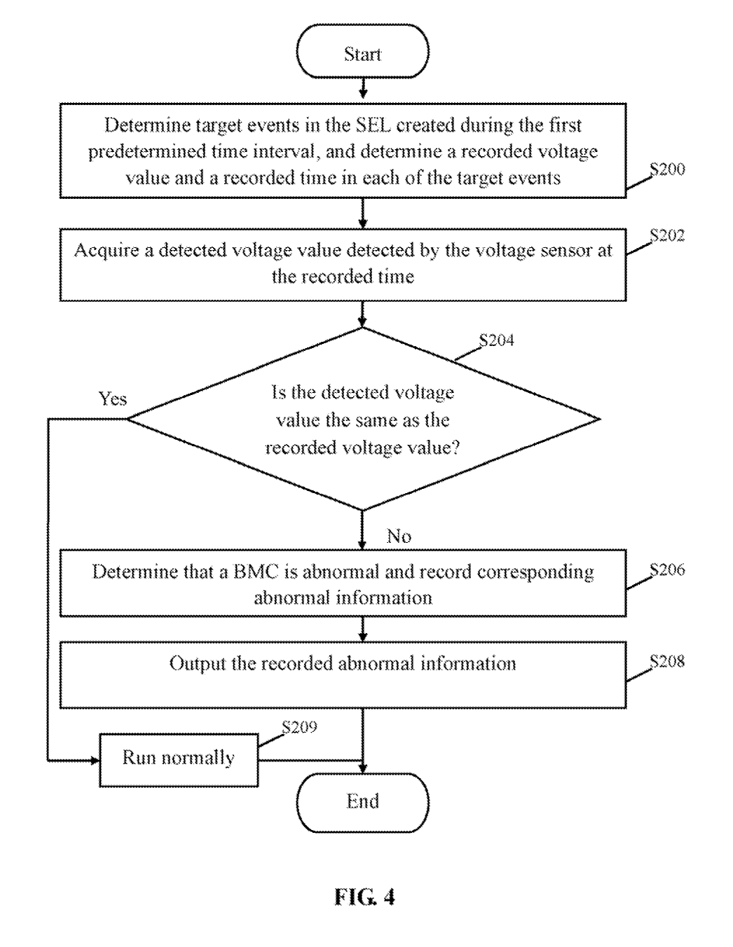

If the second number “A2” is not equal to the first number “A1”, in step S20, the parsing module 108 executes a parsing procedure. The detailed descriptions on the parsing procedure, referring to FIG. 4, are provided below. After executing the parsing procedure, the procedure in FIG. 3A returns to step S12.

If the second number is equal to the first number, in step S22, the calculation module 103 calculates a difference between the second voltage “V2” and the first voltage “V1” of the voltage sensor 13, and determines an absolute value “C” of the difference.

In step S24, the determination module 104 acquires the comparison value “B” of the voltage sensor 13 from the storage device 12, and compares the comparison value with the absolute value “C” of the difference.

In step S26, the determination module 104 determines whether the absolute value “C” of the difference is more than or equal to a predetermined percentage (e.g., 60%, or two-thirds) of the comparison value “B”. If the absolute value “C” is less than the predetermined percentage of the comparison value “B”, the procedure returns to step S12.

If the absolute value of the difference is more than or equal to a predetermined percentage of the comparison value, in step S28, the recording module 105 records current time as a second time “T2” and records the absolute value “C” of the difference and the first voltage “V1” and the second voltage “V2” of the specific component in the storage device 12. Further, the counter 106 counts a number of the absolute value “C” in the storage device 12, and determines a number of abnormal events according to the number of the absolute value “C” in the storage device 12.

In step S30, the determination module 104 determines whether a time difference “T” between the second time “T2” and the first time “T1” is less than a second time interval.

If the time difference “T” is not less than the second time interval, in step S32, the initializing module 109 initializes the counter 106 to clear or delete the number of the absolute value “C” in the storage device 12, and then the procedure returns to step S12.

If the time difference “T” is less than the second time interval, in step S34, the determination module 104 determines whether the number of the absolute value “C” is equal to or more than a predetermined number. If the number of the absolute value “C” is less than the predetermined number, the procedure returns to step S12.

If the number of the absolute value “C” is equal to or more than the predetermined number, in step S36, the prompt module 107 outputs abnormal information of the specific component of the electronic device 1. As mentioned above, the prompt module 107 may output the abnormal information by means including, but are not limited to, the audible alarm using the speaker 15, lighting the alarm lamp 16, displaying the abnormal information on the display device 14, and outputting the abnormal information using the display device 14, the speaker 15, and/or the alarm lamp 16.

FIG. 4 is a flowchart of one embodiment of a parsing procedure of step S20 in FIG. 3A. Depending on the embodiment, additional steps may be added, others removed, and the ordering of the steps may be changed.

In step S200, the parsing module 108 determines target events in the SEL created during the first time interval, and determines a recorded voltage value and a recorded time in each of the target events.

In step S202, the acquiring module 101 acquires a detected voltage value of the specific component detected by the voltage sensor 13 at the recorded time.

In step S204, the determination module 104 determines whether the detected voltage value is the same as the recorded voltage value.

If the detected voltage value is different from the recorded voltage value, in step S206, the recording module 105 determines that the BMC 170 of the electronic device 1 is running abnormally, and records corresponding abnormal information of the BMC 170.

In step S208, the prompt module 107 outputs the recorded abnormal information of the BMC 170.

If the detected voltage value is the same as the recorded voltage value, in step S209, the recording module 105 determines that the BMC 170 of the motherboard 17 is running normally, and the procedure ends.

It should be emphasized that the above-described embodiments of the present disclosure, including any particular embodiments, are merely possible examples of implementations, set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure is protected by the following claims.

What is claimed is:

1. A computer-implemented method for detecting voltage of an electronic device comprising a voltage sensor and a storage device, the method comprising execution of the steps comprising:
(a) storing a difference between an upper limit and a lower limit of the voltage sensor in the storage device, and confirming the difference as a comparison value;
(b) determining a first number of events in a System Event Log (SEL) of the electronic device, acquiring a first voltage of a specific component detected by the voltage sensor, and recording a first time when acquiring the first voltage;
(c) determining a second number of the events in the SEL after a first time interval has elapsed, and acquiring a second voltage of the specific component from the voltage sensor;
(d) calculating a difference between the second voltage and the first voltage of the voltage sensor under the condition that the second number is equal to the first number, and determining an absolute value of the difference;
(e) acquiring the comparison value of the voltage sensor from the storage device, and comparing the comparison value with the absolute value of the difference;
(f) recording current time as a second time, and recording the absolute value of the difference and the first voltage and the second voltage of the voltage sensor in the storage device, under the condition that the absolute value of the difference is more than or equal to a predetermined percentage of the comparison value;
(g) determining a number of the absolute value in the storage device; and
(h1) outputting abnormal information of the voltage of the specific component when a time difference between the second time and the first time is less than a second time interval and the number of the absolute value is equal to or more than a predetermined number.

2. The method according to claim 1, further comprising:
(h2) repeating step (b) to step (g), when the time difference between the second time and the first time is less than the second time interval and the number of the absolute value is less than the predetermined number.

3. The method according to claim 1, further comprising:
(h3) initializing the number of the absolute value in the storage device to be zero and repeating step (b) to step (g), when the time difference between the second time and the first time is not less than the second time interval.

4. The method according to claim 1, further comprising executing a parsing procedure under the condition that the second number is different from the first number, the parsing procedure comprising:
determining target events in the SEL created during the first time interval;
determining a recorded voltage value and a recorded time in each of the target events;
acquiring a detected voltage value of the specific component detected by the voltage sensor at the recorded time;
determining that a baseboard management controller (BMC) of the electronic device is abnormal, and recording corresponding abnormal information, under the condition that the detected voltage value is different from the recorded voltage value; and
outputting the recorded abnormal information.

5. The method according to claim 4, wherein the parsing procedure further comprises:
determining an identifier of a voltage sensor recorded in each of the target events if the electronic device comprises a plurality of voltage sensors; and
determining a target voltage sensor according to the identifier, and acquiring a detected voltage value detected by the target voltage sensor at the recorded time.

6. The method according to claim 1, wherein the comparison value is confirmed by:
reading information of different sensors in the electronic device;
recognizing one or more voltage sensors according to the read information, the read information of the one or more voltage sensors comprising a recognition keyword, an identifier, an upper limit and a lower limit of each of the one or more voltage sensors;
storing the read information of the one or more voltage sensors into a file, and storing the file into the storage device;
calculating a difference between the upper limit and the lower limit of each of the one or more voltage sensors; and
writing the difference as a comparison value of each of the one or more voltage sensors into the file.

7. An electronic device, comprising:
a voltage sensor;
a storage device that stores a difference between an upper limit and a lower limit of the voltage sensor, the difference being confirmed to be a comparison value;
at least one processor; and
one or more modules that are stored in the storage device and executed by the at least one processor, the one or more modules comprising:
an acquiring module that determines a first number of events in a System Event Log (SEL) of the electronic device, acquires a first voltage of a specific component detected by the voltage sensor, and records a first time when acquiring the first voltage;
the acquiring module further determines a second number of the events in the SEL after a first time interval has elapsed, and acquires a second voltage of the specific component from the voltage sensor;
a calculation module that calculates a difference between the second voltage and the first voltage of the voltage sensor under the condition that the second number is equal to the first number, and determines an absolute value of the difference;
a determination module that acquires the comparison value of the voltage sensor from the storage device, and compares the comparison value with the absolute value of the difference;
a recording module that records current time as a second time and records the absolute value of the difference and the first voltage and the second voltage of the voltage sensor in the storage device, under the condition that the absolute value of the difference is more than or equal to a predetermined percentage of the comparison value;
a counter that determines a number of the absolute value in the storage device; and
a prompt module that outputs abnormal information of the voltage of the specific component when a time difference between the second time and the first time is less than a second time interval and the number of the absolute value is equal to or more than a predetermined number.

8. The electronic device according to claim 7, wherein the acquiring module, the calculation module, the determination module, the recording module, the counter, and the prompt module are invoked repeatedly, when the time difference between the second time and the first time is less than the second time interval and the number of the absolute value is less than the predetermined number.

9. The electronic device according to claim 7, wherein the one or more modules further comprises an initializing module that initializes the counter to clear the number of the absolute value in the storage device, and the acquiring module, the calculation module, the determination module, the recording module, the counter, and the prompt module are invoked repeatedly when the time difference between the second time and the first time is not less than the second time interval.

10. The electronic device according to claim 7, wherein the one or more modules further comprises a parsing module that executes a parsing procedure under the condition that the second number is different from the first number, and the parsing procedure comprising:
determining target events in the SEL created during the first time interval;
determining a recorded voltage value and a recorded time in each of the target events;
acquiring a detected voltage value of the specific component detected by the voltage sensor at the recorded time;
determining that a baseboard management controller (BMC) of the electronic device is abnormal and recording corresponding abnormal information, under the condition that the detected voltage value is different from the recorded voltage value; and
outputting the recorded abnormal information.

11. The electronic device according to claim 10, wherein the parsing module further determines an identifier of a voltage sensor recorded in each of the target events when the electronic device comprises a plurality of voltage sensors, determines a target voltage sensor according to the identifier, and acquires a detected voltage value detected by the target voltage sensor at the recorded time.

12. The electronic device according to claim 7, wherein the comparison value is confirmed by:
reading information of different sensors in the electronic device;
recognizing one or more voltage sensors according to the read information, the read information of the one or more voltage sensors comprising a recognition keyword, an identifier, an upper limit and a lower limit of each of the one or more voltage sensors;
storing the read information of the one or more voltage sensors into a file, and storing the file into the storage device;
calculating a difference between the upper limit and the lower limit of each of the one or more voltage sensors; and
writing the difference as a comparison value of each of the one or more voltage sensors into the file.

13. A non-transitory storage medium having stored instructions that, when executed by a processor of an electronic device comprising a voltage sensor and a storage device, causes the electronic device to perform a method for detecting voltage of the electronic device, the method comprising:
(a) storing a difference between an upper limit and a lower limit of the voltage sensor in the storage device, and confirming the difference as a comparison value;
(b) determining a first number of events in a System Event Log (SEL) of the electronic device, acquiring a first voltage of a specific component from the voltage sensor, and recording a first time when acquiring the first voltage;
(c) determining a second number of the events in the SEL after a first time interval has elapsed, and acquiring a second voltage of the specific component from the voltage sensor;
(d) calculating a difference between the second voltage and the first voltage of the voltage sensor under the condition that the second number is equal to the first number, and determining an absolute value of the difference;
(e) acquiring the comparison value of the voltage sensor from the storage device, and comparing the comparison value with the absolute value of the difference;
(f) recording current time as a second time and recording the absolute value of the difference and the first voltage and the second voltage of the voltage sensor in the storage device, under the condition that the absolute value of the difference is more than or equal to a predetermined percentage of the comparison value;
(g) determining a number of the absolute value in the storage device; and
(h1) outputting abnormal information of the voltage of the specific component when a time difference between the second time and the first time is less than a second time interval and the number of the absolute value is equal to or more than a predetermined number.

14. The non-transitory storage medium according to claim 13, wherein the method further comprises:
(h2) repeating step (b) to step (g), when the time difference between the second time and the first time is less than the second time interval and the number of the absolute value is less than the predetermined number.

15. The non-transitory storage medium according to claim 13, wherein the method further comprises:
(h3) initializing the number of the absolute value in the storage device to be zero and repeating step (b) to step (g), when the time difference between the second time and the first time is not less than the second time interval.

16. The non-transitory storage medium according to claim 13, wherein the method further comprises executing a parsing procedure under the condition that the second number is different from the first number, the parsing procedure comprising:
determining target events in the SEL created during the first time interval;
determining a recorded voltage value and a recorded time in each of the target events;
acquiring a detected voltage value of the specific component detected by the voltage sensor at the recorded time;
determining that a baseboard management controller (BMC) of the electronic device is abnormal and recording corresponding abnormal information, under the condition that the detected voltage value is different from the recorded voltage value; and
outputting the recorded abnormal information.

17. The non-transitory storage medium according to claim 16, wherein the parsing procedure further comprises:
determining an identifier of a voltage sensor recorded in each of the target events if the electronic device comprises a plurality of voltage sensors; and
determining a target voltage sensor according to the identifier, and acquiring a detected voltage value detected by the target voltage sensor at the recorded time.

18. The non-transitory storage medium according to claim 13, wherein the comparison value is confirmed by:
reading information of different sensors in the electronic device;
recognizing one or more voltage sensors according to the read information, the read information of the one or more voltage sensors comprising a recognition keyword, an identifier, an upper limit and a lower limit of each of the one or more voltage sensors;
storing the read information of the one or more voltage sensors into a file, and storing the file into the storage device;
calculating a difference between the upper limit and the lower limit of each of the one or more voltage sensors; and
writing the difference as a comparison value of each of the one or more voltage sensors into the file.
